(19) United States
(12) Patent Application Publication
(10) Pub. No.: US 2016/0369707 A1
(43) Pub. Date: Dec. 22, 2016

(54) METHOD FOR OPERATING AN INTERNAL COMBUSTION ENGINE

(71) Applicant: SCHAEFFLER TECHNOLOGIES AG & CO. KG, Herzogenaurach (DE)

(72) Inventors: Jens Schaefer, Herzogenaurach (DE); Andreas Thoelke, Nuernberg (DE)

(21) Appl. No.: 15/122,196

(22) PCT Filed: Dec. 11, 2014
(86) PCT No.: PCT/DE2014/200703

§ 371 Date: Aug. 29, 2016

(30) Foreign Application Priority Data
Mar. 27, 2014 (DE) 10 2014 205 767.1

(51) Int. Cl. F02D 13/02; F02D 41/08; F01L 1/34

(52) U.S. Cl. CPC F02D 13/0223; F01L 1/34; F02D 41/08

(57) ABSTRACT

The invention relates to a method for operating an internal combustion engine with varying speed comprising at least one cylinder. Said internal combustion engine comprises different adjusting devices for influencing the filing of the cylinder, that is, at least one peripheral adjusting device and at least one adjusting device which is close to the cylinder. According to the invention, the various adjusting devices are adjusted unevenly when changing the engine speed.

### CROSS-REFERENCE TO RELATED APPLICATIONS

The present application is the United States National Stage Application pursuant to 35 U.S.C. §371 of International Patent Application No. PCT/DE2014/200703, filed on Dec. 11, 2014, and claims priority to German Patent Application No. DE 10 2014 205 767.1 of Mar. 27, 2014, which applications are incorporated by reference in their entireties.

### FIELD

The invention relates to a method for operating an internal combustion engine comprising at least one cylinder and a variable valve drive, particularly embodied as a reciprocating piston engine, whereby its speed can fall below the idling speed.

### BACKGROUND

A camshaft adjustment device for automobiles is known from EP 2 591 215 B1, with which a phase position of a camshaft can be changed or adjusted to a temporarily constant phase position. In a motor start operating mode, a range of valve opening angles is adjusted via the camshaft adjustment device, which is smaller than a geometric normal range of opening angles. Using the distinctly dynamic features of the camshaft adjustment device, it shall be possible to reduce the range of valve openings to a value which results from the difference of the standard range of opening angles to an almost equivalent range of camshaft settings. Upon reaching the idling speed, according to EP 2 591 215 B1, a switching is provided to a standard operating mode, in which a constant phase position of the camshaft is adjusted.

An operating mode of a camshaft adjuster is already known for shutting off the internal combustion engine, for example from JP 2011-094581 A.

### SUMMARY

The objective of the invention is based on providing an operating method for an internal combustion engine showing variable control times, which is particularly suitable for operating phases below the idling speed, particularly for vehicles with a start-stop system.

This objective is attained according to the invention in a method for operating at least one cylinder and one internal combustion engine comprising at least one cylinder and an adjustable valve drive, as well as a control unit for an internal combustion engine, which is embodied for executing this method.

The method is used in operating phases of the internal combustion engine, in which the speed of the internal combustion engine changes. Here, the speed may increase or reduce, with the speed level sometimes being above or below the idling speed. In particular, it may relate to an operating phase in which the speed initially falls below the idling speed and then is increased again. Such a scenario is also called a “change-of-mind” situation. In this scenario, it is assumed that a shutoff process is initiated in the internal combustion engine, for example, by issuing a stop signal to the still rolling vehicle by the start-stop system, for example, when approaching a red traffic light. Due to a changed traffic situation, for example when a traffic light switches to “green,” and/or upon a command of the driver and within the scope of a “change-of-mind” situation, the speed of the internal combustion engine can be increased again before the engine comes to a complete stop, whereby for this process no starter of the internal combustion engine is required if the speed has not fallen below a certain required speed.

The invention is based on the notion that, in internal combustion engines with adjustable valve drives, typically several adjustment mechanisms are provided with which the filling of the cylinder or, in the case of motors with several cylinders, the cylinders, can be influenced. These different adjustment mechanisms are generally called peripheral adjustment devices on the one hand, and near-cylinder adjustment devices on the other hand. Here, the gas flow towards the cylinder is decisive for the classification of the adjustment devices as “peripheral” or “near-cylinder.” The gas flowing in the direction toward the cylinder initially impinges on the peripheral adjustment device, particularly a throttle flap. Additionally, an intake manifold with an adjustable length is included in the term “peripheral adjustment device.”

After flowing through the peripheral adjustment device, the inflowing gas reaches at least one element, particularly an inlet valve, which can be influenced by the near-cylinder adjustment device. The near-cylinder adjustment device can represent, for example, a camshaft adjuster, particularly an electro-mechanically operated camshaft adjuster, a valve drive with switchable cam followers, for example rocker arms, variable bucket lifters, or tappets, a sliding cam system, or an electro-hydraulically operated valve drive, if this is provided with sufficient oil pressure even at lowest speeds. Additionally, the near-cylinder adjustment device may be a part of a valve drive, which shows no mechanical connection to the crankshaft of the internal combustion engine.

In all cases, the cylinder filling of the internal combustion engine can be influenced both by the peripheral as well as the near-cylinder adjustment device, with the various adjustment devices being adjusted, according to the invention, in an unevenly acting fashion during a change of speed. This may mean, for example, that one of the adjustment devices is adjusted in the direction towards a higher cylinder filling, while the second adjustment device is adjusted in the direction of a lower filling of the cylinder.

It is also possible during a change of speed, particularly a lowering of speed, to keep one of the adjustment devices unchanged, particularly the peripheral adjustment device, while the other adjustment device is adjusted.

According to one potential embodiment of the method, during the lowering of the speed of the internal combustion engine, the peripheral adjustment device is adjusted to a higher cylinder filling compared to the near-cylinder adjustment device. This comes into consideration particularly in situations where the speed is lower than the idling speed, however, rapid acceleration of the internal combustion engine shall be possible. The peripheral adjustment device, set to a relatively high cylinder filling compared to the near-cylinder adjustment device, ensures in this case that the pressure of the intake manifold remains high in reference to a common shutoff process, which has beneficial effects upon the restart capabilities of the engine.

The method according to the invention can be used not only when restarting within the scope of a “change-of-mind” situation, but also for simply shutting off the internal combustion engine. When shutting off an internal combustion engine, there are various options for adjusting the adjustment devices which influence the cylinder filling. On the one hand, adjustments are possible which lead to a strong flow of gas and accordingly high current loss. This results in a very rapid reduction of the speed, i.e., the motor is stopped quickly, however, this coincides with the development of considerable vibrations. From an NVH (Noise Vibration Harshness) point of view, it is therefore not optimal to shut off the internal combustion engine rapidly. Any stopping of the internal combustion engine optimized from an NVH viewpoint therefore provides that the cylinder filling is minimized during the shutoff process, resulting in a soft “putting down” of the internal combustion engine. Here, though, the longer period of time for the shutdown process is disadvantageous.

These conflicting goals are attained according to the invention such that the different adjustment devices of the internal combustion engine are adjusted in a seemingly contradictory fashion with the elements adjustable by the different adjustment devices, particularly the throttle flap and the gas exchange valves, not only influencing the cylinder filling but also the pressure in the space between the above-mentioned elements.

During the shutoff process of the internal combustion engine, the near-cylinder adjustment device, particularly the camshaft adjustment unit, is preferably adjusted to an inlet valve closing time of the internal combustion engine, which is equivalent to an angular value of the crankshaft, amounting to at least 20° or 25°, preferably at least 40°, particularly preferred at least 60°, ahead or behind the lower dead center of the lower charge change of the internal combustion engine.

In a vehicle equipped with a start-stop system and when the internal combustion engine is coasting, if the speed is already below the idling speed and falls even further, preferably before reaching the speed limit at which an automatic acceleration of the internal combustion engine is no longer possible, the near-cylinder adjustment device is adjusted in the direction of a higher cylinder filling. This measure promotes a particularly rapid restart of the internal combustion engine, which cancels the shutoff process abruptly. This also applies when, in this phase of operation of the internal combustion engine, the different adjustment devices are adjusted in similar fashion. In any case, a restart signal, if it is issued before the above-mentioned speed limit is reached, can trigger a rapid and, from an NVH viewpoint, still comfortable acceleration of the internal combustion engine, with at least the near-cylinder adjustment device being adjusted in the direction of a further increased cylinder filling.

The subsequent acceleration of the internal combustion engine to idling speed occurs preferably under a significant further adjustment of the near-cylinder adjustment device. Here, starting with the time the restart signal was issued until the idling speed is reached, a change occurs from a first adjustment position to a second adjustment position, with the adjustment range of the near-cylinder adjustment device available being preferably utilized by at least one quarter, particularly by at least half. At least one of the above-mentioned adjustment positions of the near-cylinder adjustment device may coincide with an extreme position of the adjustment device. This particularly applies for near-cylinder adjustment devices, which only show discrete adjustment options. In near-cylinder adjustment devices with continuous adjustment options, during a restart process, each of the above-mentioned adjustment positions preferably differs more strongly from the other adjustment position than from the extreme position of the adjustment device, which most closely resembles the respective adjustment position.

Further, when accelerating the internal combustion engine up to idling speed and beyond, any known measures may be introduced which contribute to a higher cylinder filling. Of particular importance in this context is a potential charging of a mechanically or electrically driven compactor, for example, or a turbocharger. During the acceleration of the internal combustion engine triggered by a “change-of-mind” request, beginning at a speed below the idling speed, even brief commands issued by the driver or issued automatically, for example by a system for detecting the environment of the vehicle, may be generated within the scope of the so-called acceleration strategy. For example, the engine control can be influenced by a signal issued during the so-called re-acceleration of the internal combustion engine, i.e., the renewed acceleration after falling below the idling speed, contrary to a previously issued command, with no torque emission being requested here, but only idling operation. With such an intervention, it is already possible during the re-acceleration to reduce the filling of the cylinders to be sparked by adjusting the near-cylinder and/or peripheral adjustment device.

However, if the above-mentioned speed limit is not reached, any automatic acceleration of the internal combustion engine is by definition no longer possible here. In this case, when shutting down the internal combustion engine or when lowering the speed to a level allowing the operation of a starter, the near-cylinder adjustment device is preferably adjusted to a low cylinder filling.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a diagram showing the speed progression, as well as the settings of various adjustment devices, when shutting down an internal combustion engine;

FIG. 2 is a diagram, according to FIG. 1, showing a “change-of-mind” situation when operating the internal combustion engine; and,

FIG. 3 is a flow chart showing the interrelation of a “change-of-mind” situation.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

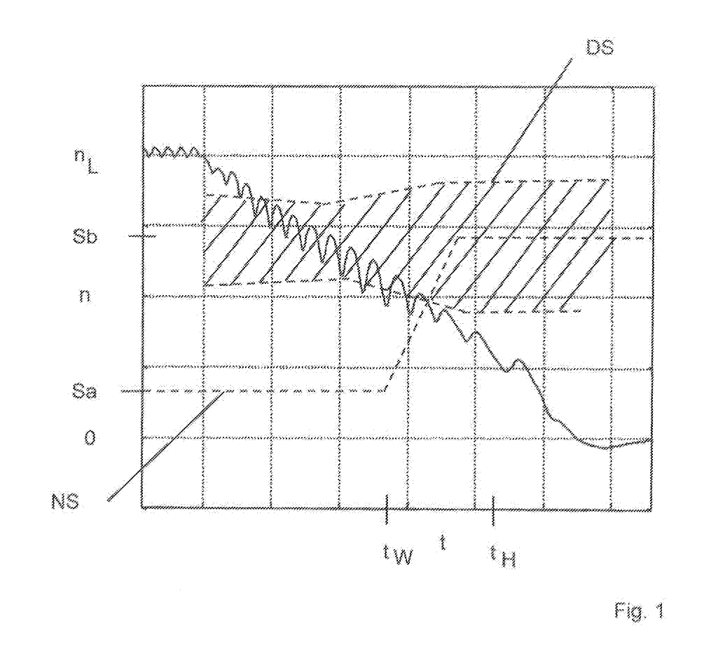

The following assumes the operation of an internal combustion engine embodied as a reciprocating piston engine, particularly showing four cylinders, also called internal combustion engine or motor for short and installed in a motor vehicle. As discernible from FIG. 1, the internal combustion engine is initially operated with speed n, which is equivalent to idling speed n_{L}. From this situation, the internal combustion engine is shut off, with a stop signal being issued, for example, by a start-stop system of the motor vehicle.

In addition to speed n of the crankshaft of the internal combustion engine, FIG. 1 shows a setting of a camshaft adjuster of the internal combustion engine, as well as a throttle flap of the internal combustion engine.

Here, the camshaft adjuster can be adjusted between first setting Sa and second setting Sb. In FIG. 1, DS indicates potential throttle flap settings of the internal combustion engine. The hatched area opening over time t symbolizes different strategies for adjusting the throttle flap when shutting down the internal combustion engine, which is discussed in greater detail in the following description. The setting of the phase angle of the camshaft, namely the inlet camshaft of the internal combustion engine in reference to the angular position of the crankshaft, camshaft setting for short, is marked NS in FIG. 1.

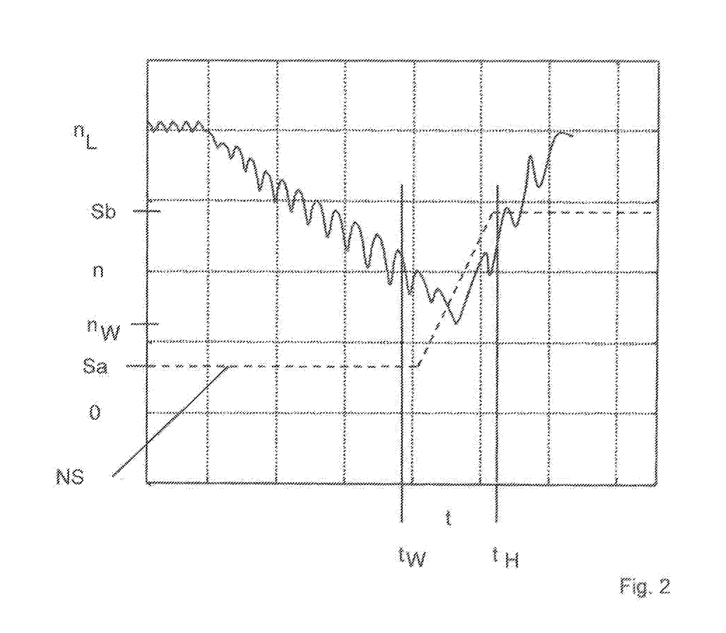

The adjustment of the camshaft adjuster from first setting Sa to second setting Sb represents an adjustment in the direction towards higher cylinder filling when the internal combustion engine is coasting. Here, the throttle flap may be kept constant. In the case of a closed throttle flap, this leads to particularly good NVH behavior and, in the case of an open throttle flap, to less optimal behavior from an NVH viewpoint. As an alternative to a constant throttle flap setting, during the shutdown of the internal combustion engine, its throttle flap or throttle flaps may be at least slightly opened, which can seem initially paradoxical. Both measures relate on the one hand to the camshaft adjuster and on the other hand to the throttle flap, which can also be applied in a combined fashion and lead to low-vibration and yet fast shutdown of the internal combustion engine. These features are particularly important when, as shown in FIG. 2, the internal combustion engine shall be restarted during the shut-off process.

The point of time, at which a restart signal is issued, is marked t_{w}. The speed limit, i.e., the minimal speed up to which the internal combustion engine can be restarted, is marked n_{w}. In the scenario according to FIG. 2, speed limit n_{w} is reached approximately at the latest acceleration time marked t_{H}. Even before the restart signal is issued, thus within this scenario in which a shutdown of the motor is assumed, the throttle flap of the internal combustion is adjusted so that rapid restarting is possible. This way, sufficiently high pressure is upheld in the intake manifold of the internal combustion engine in order to, by a rapid adjustment of the camshaft adjuster, also called near-cylinder adjustment device, allow a rapid acceleration of the internal combustion engine. As a distinction from the camshaft adjuster, the throttle flap is called a peripheral adjustment device.

Particularly when re-accelerating the internal combustion engine, the advantages of the apparently contradictory activation of different adjustment devices are effective in the speed rate below idling speed n_{L}. In particular in an initial phase of the shutdown process, when the speed is reduced, the near-cylinder adjustment device may be adjusted at least slightly in the direction of a higher cylinder filling in order to prepare for a potential “change-of-mind” situation.

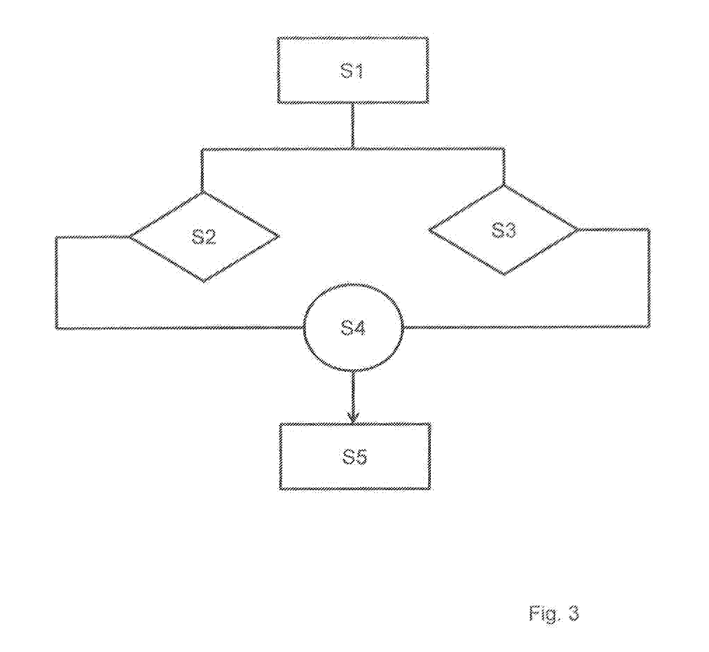

Based on FIG. 3, some conditions are explained in the following, which must be fulfilled for the scenario according to FIG. 2, i.e., the restart of the internal combustion engine within the scope of a “change-of-mind” situation.

A shutdown process is initiated in processing step Sl. This can occur either by the explicit desire of the driver or by a start-stop system. The start-stop system can, for example, be capable of detecting a red traffic light so that the shutdown process is already introduced when the vehicle is still rolling.

After the shutdown process has been initiated, with the motor still running, a permanent check occurs in processing step S2 to determine if a restart of the internal combustion engine is still possible, i.e., if a “change-of-mind” situation could be considered. Simultaneously, a check is made in processing step S3 to determine if a “change-of-mind” request was issued by the driver. Alternatively, a “change-of-mind” decision could also be rendered automatically, for example, by a visual detection and evaluation of the environment of the motor vehicle.

If both conditions set in steps S2 and S3 are fulfilled, in step S4 the decision is automatically rendered to initiate the restart. The restart process itself, i.e., the acceleration of the internal combustion engine at least to idling speed n_{L}, is marked as step S5 in FIG. 3.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

DS Throttle flap setting

n Speed

n_{L} Idling speed

n_{w} Speed limit

NS Camshaft setting

Sa First setting of the camshaft adjuster

Sb Second setting of the camshaft adjuster

S1 Processing step

S2 Processing step

S3 Processing step

S4 Processing step

S5 Processing step

t Time

t_{H} Acceleration point of time

t_{w} Time for requesting restart

1-10. (canceled)

11. A method for operating an internal combustion engine comprising at least one cylinder with a changing speed, with the internal combustion engine comprising different adjustment devices for influencing the filling of the at least one cylinder, namely at least one peripheral adjustment device and at least one near-cylinder adjustment device, and where, in case of a change of speed, the various adjustment devices being adjusted in differently acting fashions.

12. A method as recited in claim 11, wherein a throttle flap is provided as the peripheral adjustment device and a camshaft adjuster as the near-cylinder adjustment device.

13. A method as recited in claim 12, wherein the speed of the internal combustion engine is reduced, with the peripheral adjustment device being adjusted in reference to the near-cylinder adjustment device to a higher cylinder filling.

14. A method as recited in claim 12, wherein by the near-cylinder adjustment device an inlet valve of the internal combustion engine is adjusted, which is equivalent to an angular value of the crankshaft of the internal combustion engine, which deviates by at least 20° from the lower dead center of the charge change of the internal combustion engine.

15. A method as recited in claim 14, wherein the speed is reduced to a value below the idling speed of the internal combustion engine with, before a speed limit is reached up to which an automatic re-acceleration of the internal combustion engine is still possible, the near-cylinder adjustment device being adjusted in the direction of a higher cylinder filling.

16. A method as recited in claim 15, wherein at a speed below the idling speed a restart signals triggers an adjustment of the near-cylinder device in the direction towards increased cylinder filling.

17. A method as recited in claim 16, wherein during the re-acceleration of the internal combustion engine, before the idling speed is reached, the near-cylinder adjustment device is adjusted from a first setting to a second setting, with the adjustment range of the near-cylinder adjustment device available being used by at least one fourth.

18. A method as recited in claim 17, wherein each of the first and second settings differ more strongly from the other adjustment position than from an extreme position of the adjustment device most closely resembling the respective setting.

19. A method as recited in claim 15, wherein after the idling speed has fallen short the near-cylinder adjustment device is adjusted to a low cylinder filling.

20. A control unit for an internal combustion engine, embodied to execute the method as recited in claim 11.
